(19) United States
(12) Patent Application Publication
(10) Pub. No.: US 2010/0127518 A1
(43) Pub. Date: May 27, 2010

(54) ELECTRIC STRIKE

(76) Inventor: Jih-Hui Huang, Taipei County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/544,646

(22) Filed: Aug. 20, 2009

(30) Foreign Application Priority Data
Nov. 26, 2008 (TW) 097221177

(51) Int. Cl. E05B 15/02

(52) U.S. Cl. 292/341.16

(57) ABSTRACT

An electric strike that facilitates setting a door security mode includes a housing, a lever, an electromagnetic actuating device, and an adjustment device adapted to be fitted through the housing formed with a chamber and a recess. The lever is able to rotate in the chamber or stretch towards outside and has a first locking device. The electromagnetic actuating device can be moved linearly in the recess and is connected to a second locking device. The adjustment device can be moved parallel to the longitudinal axis of the electromagnetic actuating device with one of its ends abutting against the electromagnetic actuating device and the other end able to be manipulated from outside of the electric strike to change the door security mode, thereby the second locking device is moved to a locked position or an unlocked position with respect to the first locking device when the power is off.

### BACKGROUND OF THE INVENTION

1. Field of the Invention

The present invention relates to a structure of an electric strike and more particularly, to a structure of an electric strike in which a set mode of the electric strike can be conveniently adjusted from the outside of the electric strike, such that the electric strike is either in a locked or unlocked state when the power is off.

2. Description of the Prior Art

An electric strike is commonly used to control the ingress and egress to buildings. The electric strike is provided with an electromagnetic actuating device that can convert electricity to mechanical force. In general, the electromagnetic actuating device is either an electrically driven motor or a solenoid device. With the power on or off, the driving device enables the latch of a door to be lock or unlock.

Generally, an electric strike has two modes. One mode is called “fail-secure,” where the electric strike is not powered on and a “locked” state is presented. When the electric strike is powered on through an externally connected control system such as a card machine or a card reader, an internal actuating device is activated to unlock the latch. The second mode is called “fail-safe,” where the electric strike is continuously powered on and in a normal locked situation. When the electric strike is powered off, the internal actuating device is activated to achieve an “unlocked” state. Some electric strikes only have one of the above modes, and no selection can be made. However, the electric strike described in this present invention may be selected to set to either of the two modes above when it is installed or by operations after installed by an operator.

In the prior art, such as U.S. Pat. No. 6,299,225, an electric strike with the structure shown as FIG. 1A and FIG. 1B is disclosed. Its “mode select” function is achieved by the main elements which include a housing 60, a lever 61, a solenoid device 62 fixed to a mount 621 comprising a plunger 622 slideable in the solenoid and a block 623 fixed to one end of the plunger 622. In the mount 621 are provided a plurality of bottom screw holes 624, which are distributed at the front end and the back end of the mount respectively. The housing 60 is provided with a correspondingly disposed elongated slot 65 and two screw holes 66 in tandem. An adjustment screw 67 is used to pass through the elongated slot 65 of the housing 60 and is locked into one of the screw holes 624 in the mount 621 close to the block 623. A tie screw 68 is used to pass through one of the screw holes 66 in the housing 60 and is locked into one of the screw holes 624 in the mount away from the block 623. In practical operations, as an operator selects to lock the tie screw 68 into the screw hole 66 close to the right side or the center of the housing 60, so that until the power is on or off, the solenoid device can drive the block 623 to a position in which it resists against the lever 61 to prevent it from rotating to unlock the door, thereby the effect of the door security mode selection is achieved. However, the structure described above is complicated. If desired, to switch between the different modes, the operator has to loosen the adjustment screw 67 followed by the tie screw 68, push the adjustment screw 67 by toggling with an external force to enable the mount 621 and the solenoid device to translate a distance, then lock the tie screw 68 into another tie screw hole. The operation procedure above is considerably complicated.

Another U.S. Pat. No. 6,874,830 disclosed an improved structure. As shown in FIGS. 2A, 2B and 2C, the structure is provided with an actuating device, which also is a solenoid 72. Similarly, a plunger of the solenoid 72 is attached with a blocking element 74 and a keeper 71. The blocking element 74 has two projections. The keeper 71 also has two projections. When the two projections of the blocking element 74 are just moved to a position in which they are opposite to the two projections of the keeper 71, the operation of the keeper 71 is blocked and the door therefore cannot be opened. The solenoid is fixed to a holder 73, which is equivalent to the mount 621 described above. The main difference between the structure of U.S. Pat. No. 6,874,830 and U.S. Pat. No. 6,299,225 is that the former patent employed an eccentric wheel device as a two-position mode selector 76. The eccentric wheel device 76 is joined with a disk 763 at its both sides by two eccentrically disposed posts 761, 762. The post 761 is exposed to the outside of a housing 70, and has a tool notch thereon by which the post 761 can be rotated by a screw driver. The post 762 is embedded into a slot in the holder 73. If desired to switch a mode, the holder 73 carrying the solenoid 72 and the blocking element 74 may be pushed indirectly to slide in the housing 70 simply by using a screw driver to rotate the eccentric device 76 from outside. As such, the two projections of the blocking element 74 are aligned or staggered with the two projections of the keeper 71, such that the selection of either a fail-secure or a fail-safe mode is achieved. Although this eliminates the annoyance of the necessity of removing the outer cover at the time of mode setting, such an eccentric wheel device is operative to convert a rotational torque into a linear movement. If the structure is not properly designed to constrain the solenoid and the blocking element to move in a linear direction, a part resisted against by the eccentric wheel may deflect upwards or downwards from the friction, thereby leading to instability. Furthermore, the construction of such a device is complicated, and the manufacturing and assembling of its parts is not cost effective.

### SUMMARY OF THE INVENTION

An objective of the present invention is to provide an electric strike structure of which the door security mode is changeable, and more particularly to an electric strike structure of which the door security mode can be changed easily by an ordinary operator from outside.

Another objective of the present invention is to provide an electric strike structure of which the door security mode is changeable and requires no complex machining.

Furthermore, another objective of the present invention is to provide an electric strike structure of which the door security mode is easily adjustable and accessible, cost-effective in assembly and can be stably operated.

### BRIEF DESCRIPTION OF THE DRAWINGS

FIG. 1A and FIG. 1B are a structural exploded view and an assembly view of a structure in the prior art respectively.

FIG. 2A-2C are a structural exploded view, an internal mode selection device, and an eccentric wheel device used for mode selection in the prior art respectively.

FIG. 3 is an exploded view of the structure of a first embodiment according to the present invention.

FIG. 4 is an exploded view of the structure of the actuating device of the present invention.

FIG. 5 is a sectional assembly view of the first embodiment according to the present invention.

FIG. 6 is a perspective view of the first embodiment according to the present invention.

FIG. 7A is a front view of the first embodiment according to the present invention with a bottom cover removed, in which the mode is set to “fail-safe.”

FIG. 7B is a sectional view of the first embodiment according to the present invention taken along the line 7B-7B in FIG. 7A.

FIG. 7C shows the locked state upon powering on of the first embodiment according to the present invention after set to the “fail-safe” mode.

FIG. 7D is a sectional view of the first embodiment according to the present invention taken along the line 7D-7D in FIG. 7C.

FIG. 8A is a front view of the first embodiment according to the present invention with the bottom cover removed, in which the mode is set to “fail-secure.”

FIG. 8B is a sectional view of the first embodiment according to the present invention taken along the line 8B-8B in FIG. 8A.

FIG. 8C shows the unlocked state upon powering on of the first embodiment according to the present invention after set to the “fail-secure” mode.

FIG. 8D is a sectional view of the first embodiment according to the present invention taken along the line 8D-8D in FIG. 8C.

FIG. 9 is an exploded view of the structure of a second embodiment according to the present invention.

FIG. 10 is an exploded view of an adjustment device used in the second embodiment according to the present invention.

FIG. 11A is a front view of the second embodiment according to the present invention after assembling with the bottom cover removed, in which the mode is set to “fail-safe.”

FIG. 11B is a sectional view of the second embodiment according to the present invention taken along the line 11B-11B in FIG. 11A.

FIG. 11C shows the locked state upon powering on of the second embodiment according to the present invention after set to the “fail-safe” mode.

FIG. 11D is a sectional view of the second embodiment according to the present invention taken along the line 11D-11D in FIG. 11C.

FIG. 12A is a front view of the second embodiment according to the present invention after assembling with the bottom cover removed, in which the mode is set to “fail-secure”.

FIG. 12B is a sectional view of the second embodiment according to the present invention taken along the line 12B-12B in FIG. 12A.

FIG. 12C shows the unlocked state upon powering on of the second embodiment according to the present invention after set to the “fail-secure” mode.

FIG. 12D is a sectional view of the second embodiment according to the present invention taken along the line 12D-12D in FIG. 12C.

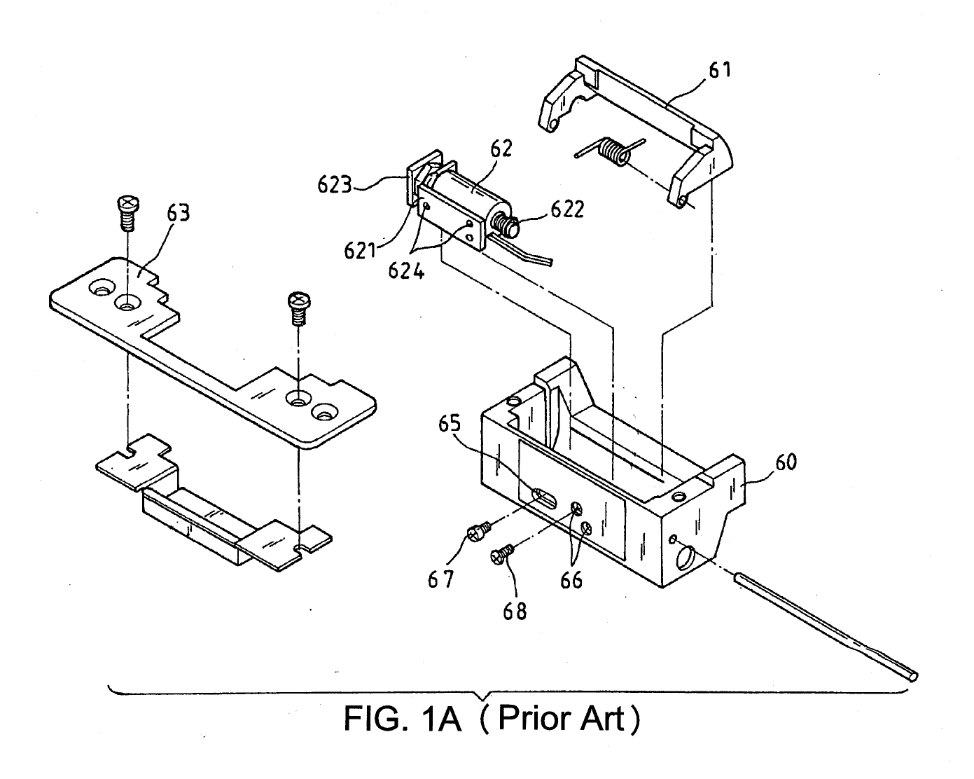

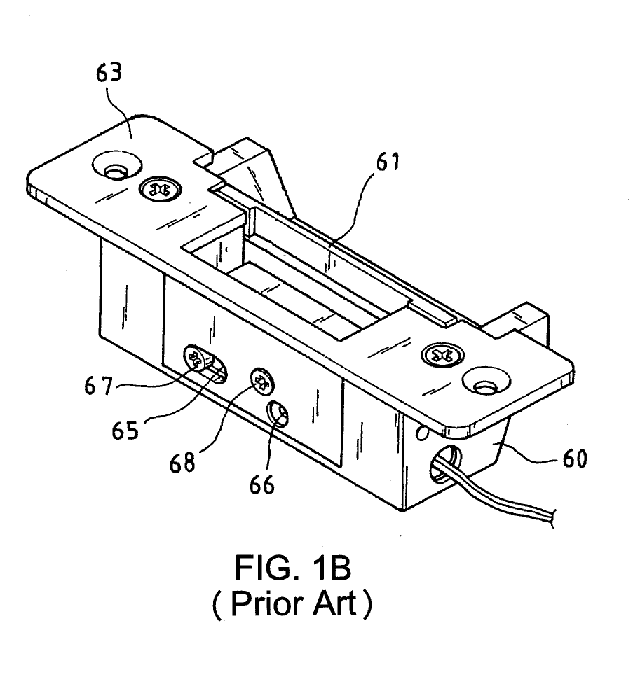

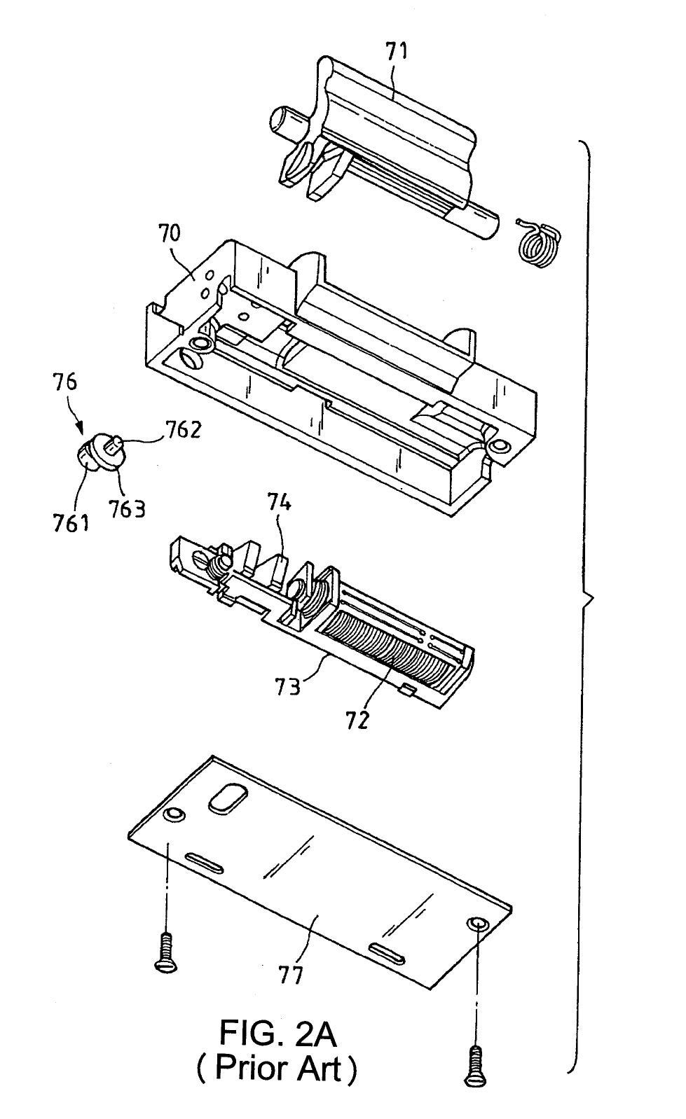

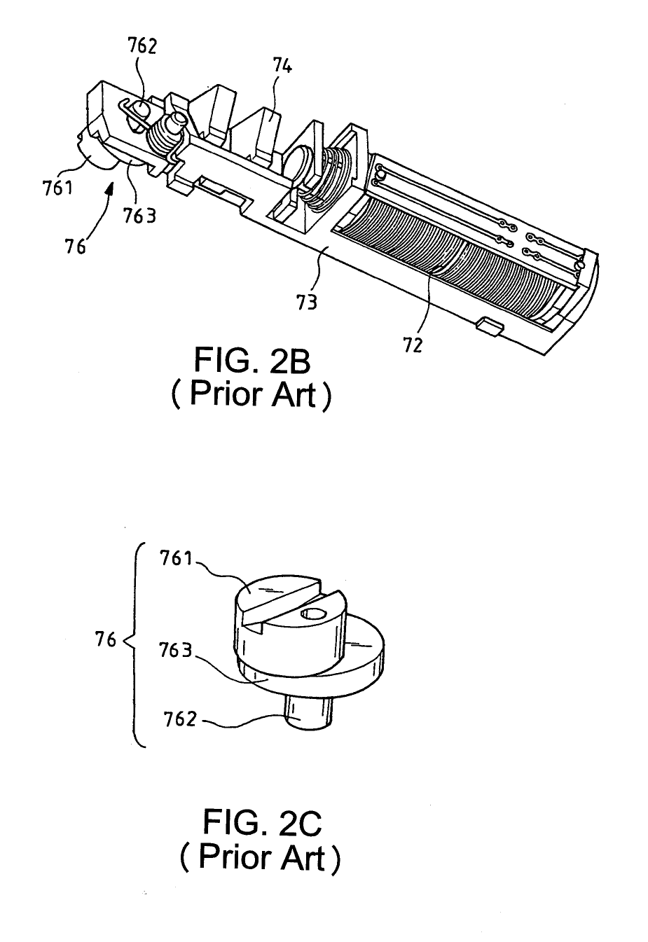

### DETAILED DESCRIPTION

The preferred embodiments of the present invention are illustrated in the following description in conjunction with accompany drawings, in which the reference numerals are used to represent corresponding elements.

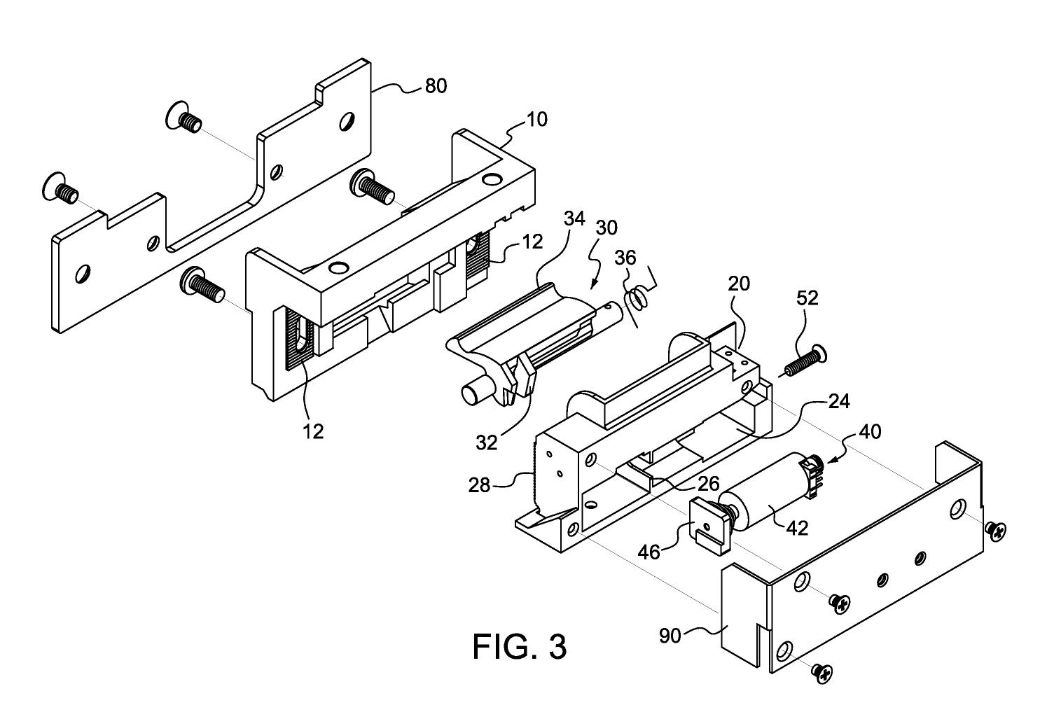

FIG. 3 is an exploded view of the structure of an electric strike according to a first embodiment of the present invention. Referring to FIG. 3, the electric strike includes a base 10, a shell 20, a lever 30, and an electromagnetic actuating device 40. The base 10 and the shell 20 are fixed to an opposite position with respect to each other to form a housing, in which a space is formed to accommodate the lever 30 and enable it to rotate a particular angle or telescope a distance. The space may be formed by a chamber formed in the base 10 and a recess 24 formed in the shell 20, and at least enables a locking plate 34 of the lever 30 to protrude from the base 10 to face a surface of a corresponding lock mouth in the doorframe or door panel when the electric strike is in a locked state. As such, the locking plate 34 may be engaged with the corresponding lock mouth in the doorframe or door panel to lock the door. The recess 24 of the shell 20 is used to accommodate the electromagnetic actuating device 40. The recess 24 allows the actuating device 40 to move a distance therein in a linear direction.

In order to facilitate a stable positioning of the base 10 and the shell 20 during assembling and prevent the relative position of the base 10 and the shell 20 from shifting too much as a result of the shock due to frequent opening and closing of the door, a plurality of sawtoothed slots 12, 28 which can be engaged with each other are provided on the shell 20 and the base 10 respectively. The sawtoothed slots may be used to make the relative position of the base 10 and the shell 20 during assembling shift one to several teeth. The purpose is to adjust the position of the locking plate 34 of the lever protruding from the base 10, in order to make the position correspond to the position of the corresponding lock mouth in the door panel or doorframe.

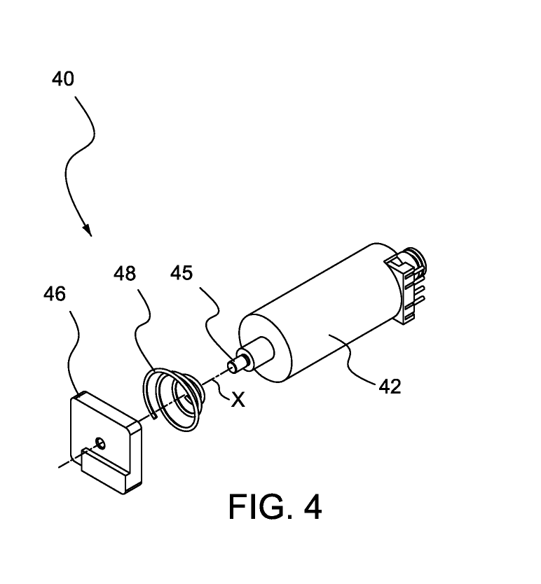

FIG. 4 shows that the electromagnetic actuating device has a longitudinal axis X. Referring to FIG. 4, the electromagnetic actuating device 40 may comprise several parts including a solenoid 42 which includes an actuating rod 45, a second locking device which may be a block 46, and an elastic body 48 which can be a compression spring disposed between the block 46 and the solenoid 42. The actuating rod 45 may stretch a particular distance from the solenoid 42 due to the electromagnetic force when the solenoid 42 is powered on. The block 46 is fixed to one end of the actuating rod 45. The solenoid 42 enables the actuating rod 45 to stretch or retract by the electromagnetic force in a powered on or powered off state, thereby causing the block 46 to reciprocate in a linear direction. As shown in FIG. 3, the lever 30 is provided with a first locking device, which may be a bump 32. It penetrates through at least a portion of the space accommodating the lever 30 in the housing of the electric strike formed by the base 10 and the shell 20, to a recess 24 on the shell 20. Therefore, when the electromagnetic force causes the solenoid 42 to push the block 46 to move in the recess 24, the bump 32 and the block 46 in the recess 24 may be in a position in which they are opposite to each other and able to resist against each other. In such a position, the lever 30 cannot be rotated to unlock the door. Therefore, such a position is called a “locked position.” When the block 46 and the bump 32 are staggered and do not resist against each other, the lever 30 can be rotated a certain angle or telescoped a distance in the space formed by the base 10 and the shell 20. At that time, the locked state is released, and such a position is called an “unlocked position.”

As shown in FIG. 3, a spring 36 may be disposed between the lever 30 and the base 10 or the shell 20, such that when the electric strike is powered off, the lever 30 may be fixed at a rotational angle or a protruded position by a spring force. Other than being in the form of a bump 32, the first locking device may also be any mechanism that can engage with the second locking device (i.e., block 46) of the actuating device 40 to prevent the lever 30 from rotating or telescoping when the second locking device is moved to a locked position.

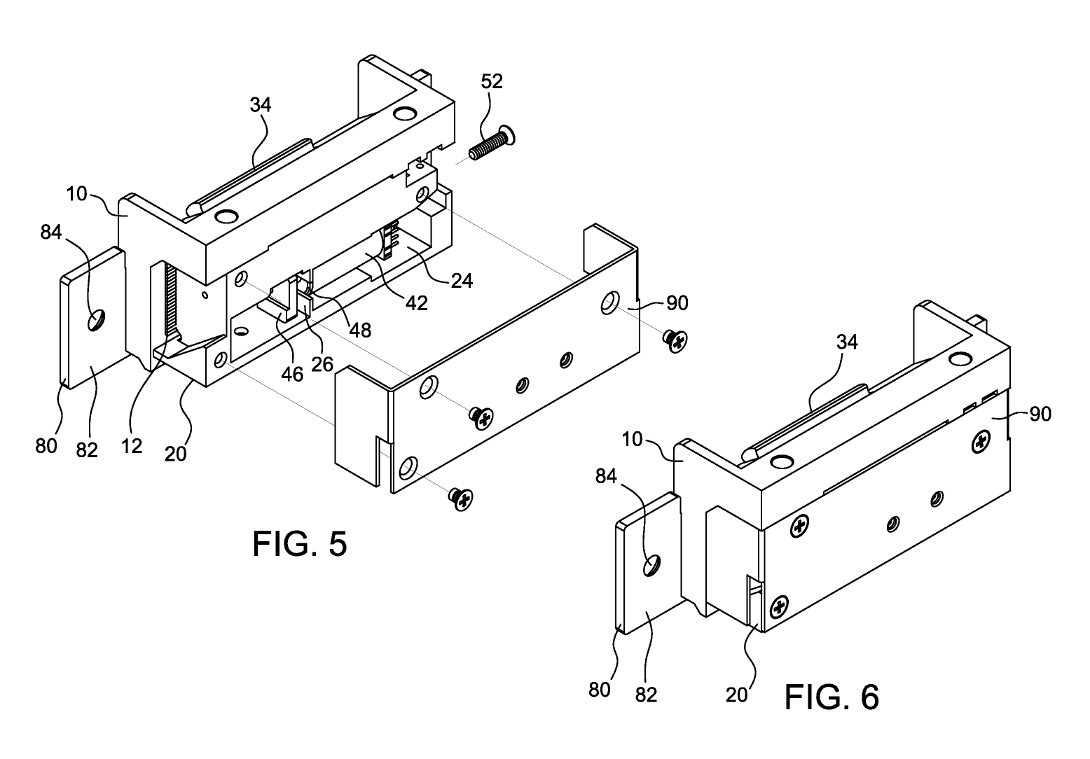

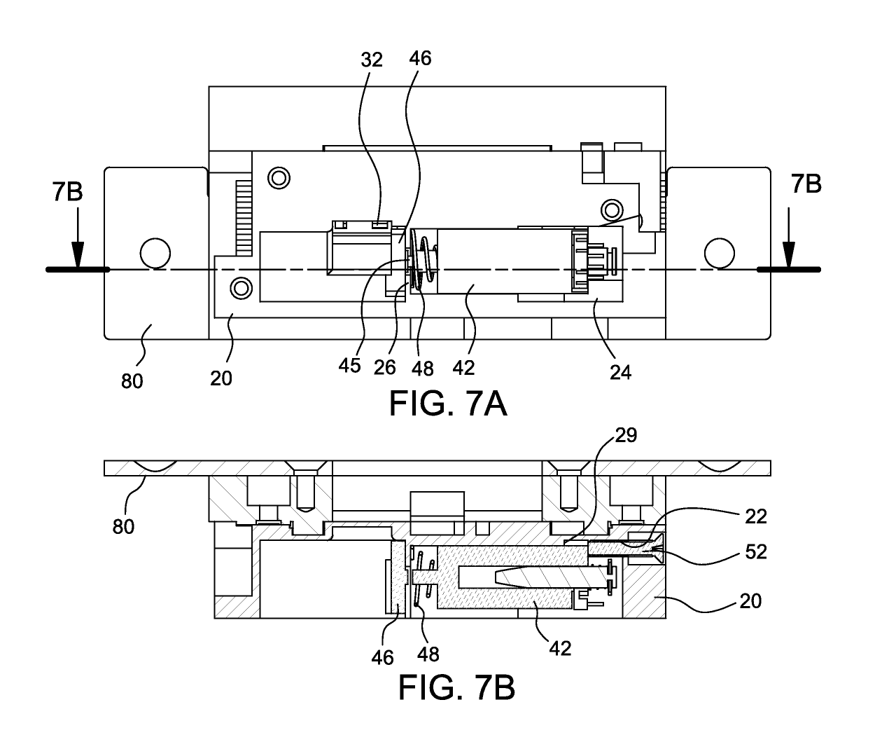

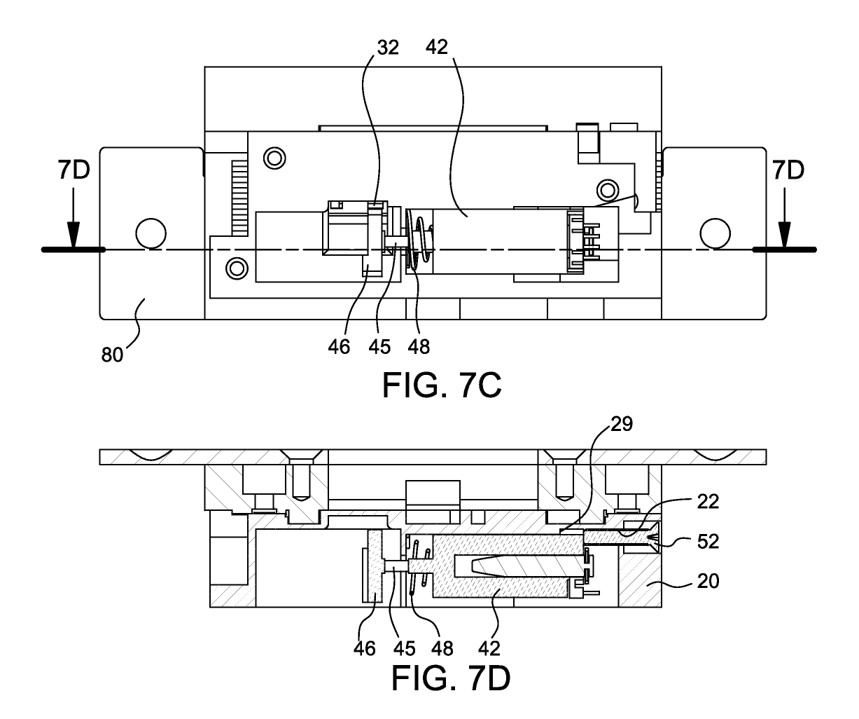

FIG. 3, FIG. 5, and FIG. 7B show a mechanism that is mainly used to set a “fail-safe” mode or a “fail-secure” mode of the electric strike. The mechanism includes an electromagnetic actuating device 40, an adjustment device 52 penetrating one side of the shell 20 to resist against an end of the cylindrical cover of the solenoid 42 directly, and a hole 22 located in the shell 20 for the adjustment device 52 to penetrate to resist against the solenoid 42 (FIG. 7B). A locating stub 26 is provided in the recess 24 of the shell 20 for one end of the elastic body 48 of the electromagnetic actuating device 40 to abut against, thereby elastically biasing the solenoid 42 into a neutral position in the recess 24. In the first embodiment as shown in FIG. 3, FIG. 5, and FIG. 7A-7D, the adjustment device 52 is a screw of which the length is fixed. The adjustment device 52 may be rotationally disposed on the shell 20, and may move axially parallel to the longitudinal axis direction X of the electromagnetic actuating device 40. A hole 22 with its axis substantially parallel to the axis X is provided in the shell 20 for the screw 52 to penetrate through, with threads formed therein to engage with the screw 52. Where the screw 52 is not threaded into the hole 22, or the screw 52 is threaded into the hole 22 from outside and the front edge of the screw 52 merely touch upon an end of the cylindrical cover of the solenoid 42, the solenoid 42 is located in the neutral position as shown in FIG. 7A and FIG. 7B. Such that the block 46 fixed to the front end of the actuating rod 45 is in a staggered position with respect to the bump 32 of the lever 30 (i.e., unlocked position). At that time, a “fail-safe” mode is set. Preferably, as shown in FIG. 7B, the hole 22 is in a form of a counterbore butted with a threaded hole, and the depth of the counterbore may be set to a constant value according to the length of the screw 52 to be threaded into the hole 22. When the solenoid 42 is in the neutral position as shown in FIG. 7B, the head of the screw 52 is approximately flushed with the outmost edge of the counterbore of the hole 22.

FIG. 7C and FIG. 7D show the effect of the electric strike powered on as the “fail-safe” mode. Referring to FIG. 7C and FIG. 7D, when the electric strike is powered on, an electromagnetic force causes the actuating rod 45 to push the block 46 to a position in which the block 46 is just opposite to the bump 32 of the lever 30 and resists against it (locked position) to result in the door being locked. When the electric strike is powered off, the electric strike goes back to the unlocked state as shown in FIG. 7A and FIG. 7B.

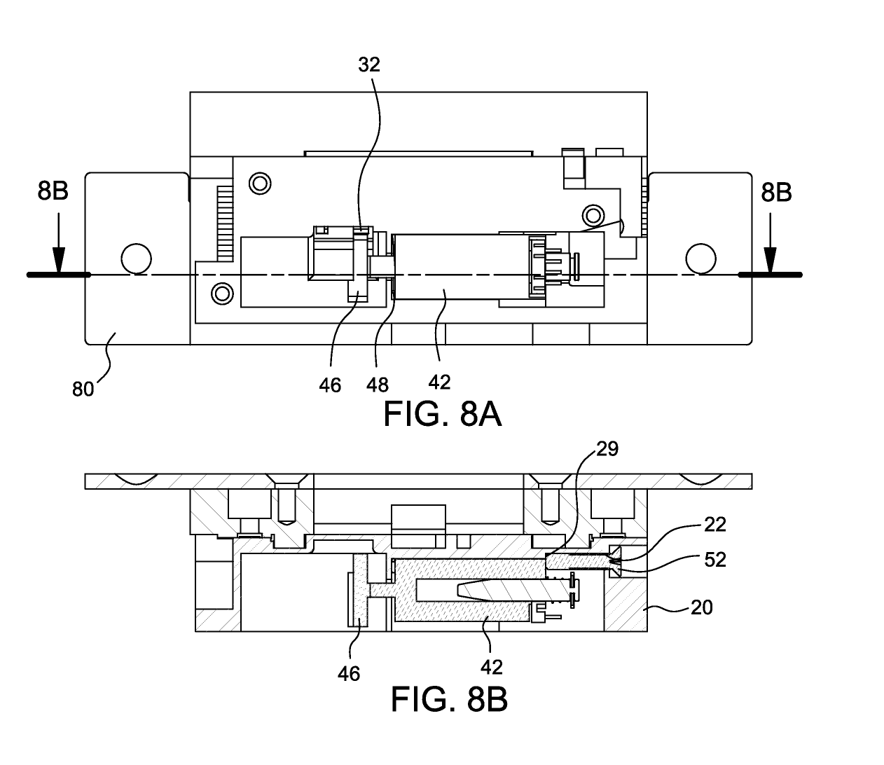

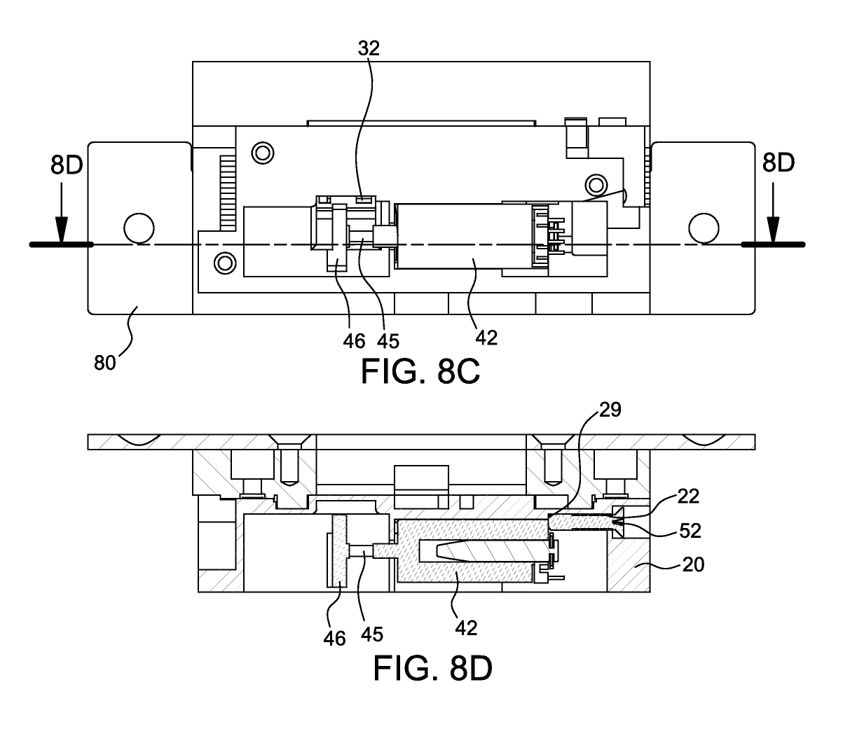

FIG. 8A and FIG. 8B show the manner of setting the first embodiment of the electric strike in the “fail-secure” mode. Referring to FIG. 8A and FIG. 8B, when the electric strike is powered off, the screw 52 is threaded into the hole 22 with the head of the screw 52 in contact with the bottom of the counterbore of the hole 22. The threaded-in distance just enables the screw 52 to push the electromagnetic actuating device 40 to the “locked position” in which the block 46 is opposite to the bump 32 of the lever 30 and resists against it. Moreover, a step surface 29 may be formed at a position in the recess 24 in close proximity to the solenoid 42. Such that after the screw 52 is threaded into the hole 22, a part of the end of the screw 52 resists against the step surface 29, thereby preventing the screw 52 to be excessively threaded in. In order to locate the screw 52 at such a position tightly without loosening, a lock washer (not shown) may be disposed in the space between the exterior of the head of the screw 52 and the counterbore. If powered on at that time, the state of the electric strike may be changed to the state as shown in FIG. 8C and FIG. 8D. Due to the electromagnetic force, the block 46 is moved forward to a position in which it is staggered with the bump 32 (unlocked position). Therefore, an unlocked state is achieved, and the set of the “fail-secure” mode is finished.

FIG. 5 is a perspective view of the assembly structure according to the first embodiment. Referring to FIG. 5, a bottom cover 90 is not assembled to the electric strike yet. A top cover 80 and the bottom cover 90 may be optional members, because a fixing ear 82 used for fixing to a doorframe or door panel together with a fixing hole 84 may be a structure that can be molded onto the base 10 directly. The recess 24 of the shell 20 may form a device directly to constrain the actuating device 40 to move linearly and not to disengage with the recess 24. Therefore, the bottom cover 90 may be omitted.

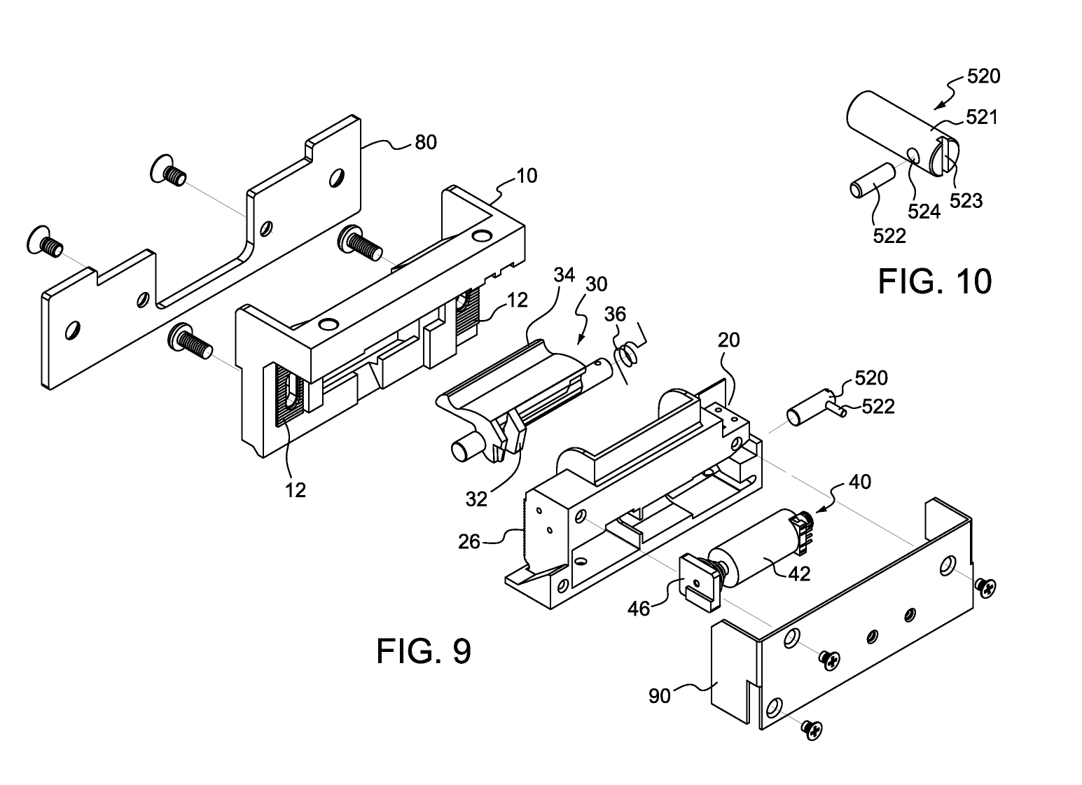

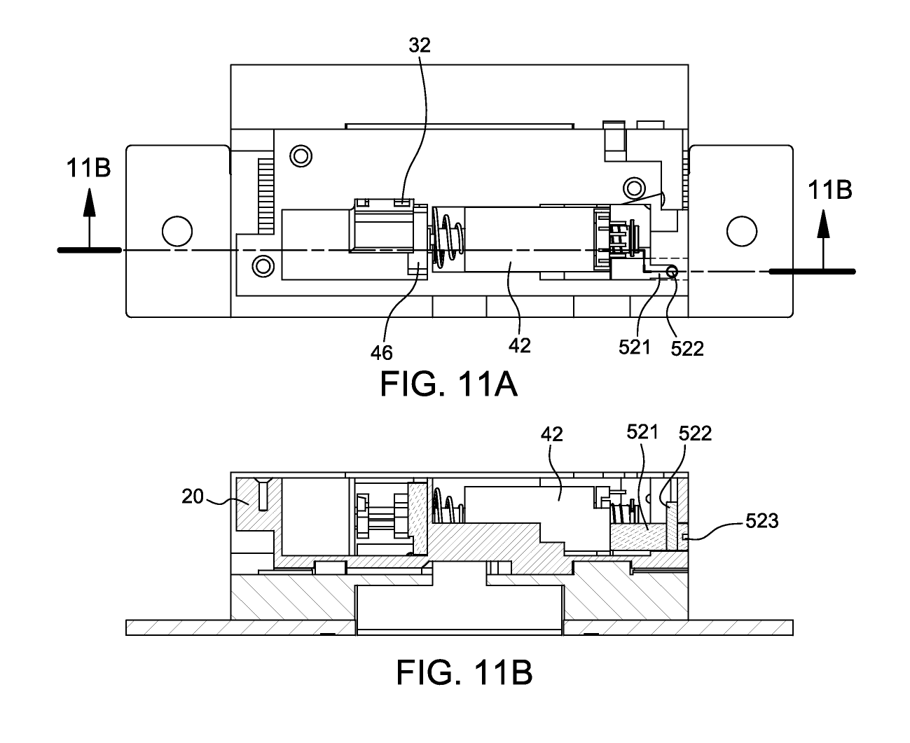

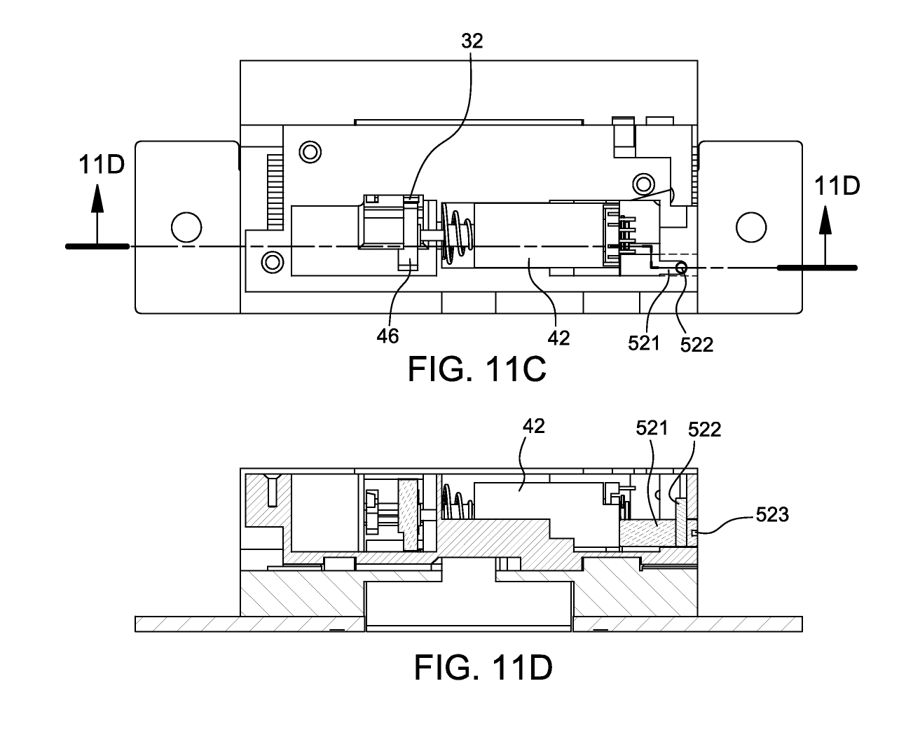

In a second embodiment of the present invention, the adjustment device may also be a mechanism as shown in FIG. 9 and FIG. 10. The adjustment device 520 includes a stick 521 and a pin 522. On the surface of the stick 521 facing outward, there is a tool notch 523 used for operating by a hand tool from outside. The adjustment device 520 is rotationally disposed on the shell 20, and may move axially parallel to the longitudinal axis X of the electromagnetic actuating device 40. After penetrating through the round hole 22 in the shell 20 in the assembly process, the stick 521 fixes the pin 522 into a fixing hole 524 in the side surface of the stick 521, such that the entire adjustment device presents an “L” shape. A flat step is provided at a place where the recess 24 of the shell 20 joins with the hole 22 as shown in FIG. 11A, for providing a two-stage locking position for the pin 522. When the stick 521 is moved in the direction parallel to the axis X and then rotated by a screw driver externally to rest the pin 522 at the first stage as shown in FIG. 11A and FIG. 11B, the front edge of the stick 521 butts one end of the solenoid 42, and pushes the solenoid 42 to enable the block 46 fixed to the front end of the actuating rod 45 and the bump 32 of the lever 30 to be in a staggered position (unlocked position). As such, the set of the “fail-safe” mode is complete. FIG. 11C and FIG. 11D show that when the electric strike is powered on, the block 46 and the bump 32 of the lever 30 present a butting state (locked position) and the door locked.

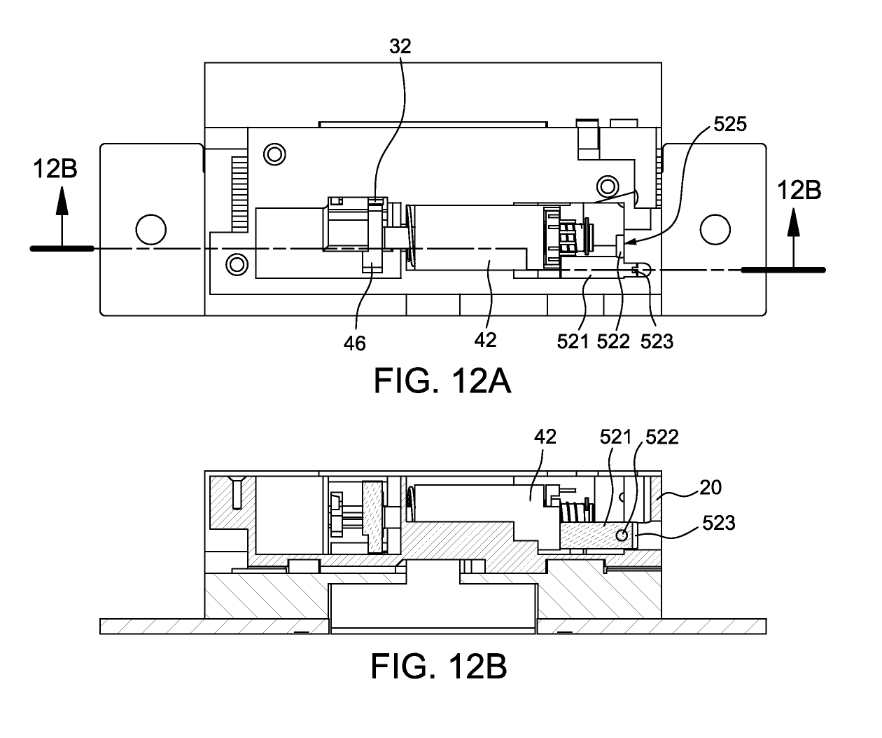

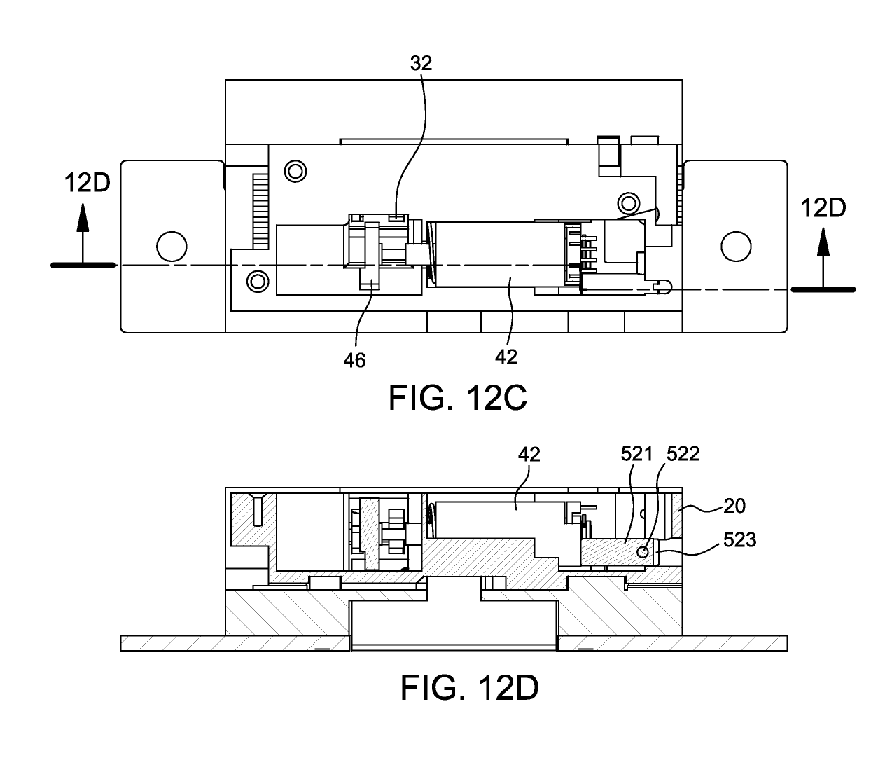

As shown in FIG. 12A and FIG. 12B, when the stick 521 is moved and then rotated by a screw driver externally to enable the pin 522 to move towards the solenoid 42 and rotate about 90 degrees, thereby being rested at a second stage plane 525 as shown in FIG. 12A, the front edge of the stick 521 pushes the cylindrical cover of the solenoid 42. As such, the block 46 is moved to a position in which it abuts against the bump 32 of the lever 30 (locked position). At that time, the set of the “fail-secure” mode is complete. FIG. 12C and FIG. 12D show that when the electric strike is powered on, the block 46 is in a position in which it is staggered with the bump 32 of the lever 30 (unlocked position) and the door unlocked.

The present invention achieves a simplified part assembling and effective door security mode adjusting method. As compared to the prior art with multiple assembling many parts or mode adjustments, the present invention has novel and inventive features.

As described above, the variations and modifications may be made without departing the spirit of the present invention. They should be considered as falling within the coverage of description of the present invention.

We claim:

1. An electric strike, comprising:
a housing, formed with a chamber and a recess therein;
a lever, disposed in the chamber and able to rotate an angle in the chamber, the lever is provided with a first locking device;
an electromagnetic actuating device, having a longitudinal axis and disposed in the recess, the recess allowing the electromagnetic actuating device to move a distance linearly therein in the direction of the longitudinal axis; a second locking device disposed on the electromagnetic actuating device, wherein a displacement of the second locking device in the direction of the longitudinal axis generated when an electromagnetic force is applied to it;
an adjustment device, adapted to be fitted through the housing in a manner that it can be moved parallel to the longitudinal axis of the electromagnetic actuating device, one end of the adjustment device abutting against the electromagnetic actuating device, the other end of the adjustment device able to be manipulated from outside of the electric strike to change its position;
wherein when a door security mode is set, a position of the adjustment device is changed linearly by manipulating from outside of the housing to push the electromagnetic actuating device to move a distance in the recess along the longitudinal axis direction, then the second locking device is moved to a locked position or an unlocked position with respect to the first locking device, a displacement of the second locking device on the electromagnetic actuating device is generated when an electromagnetic force is applied, the displacement enables the second locking device to change from the set locked position to the unlocked position, or from the set unlocked position to the locked position.

2. The electric strike according to claim 1, wherein:
the electromagnetic actuating device is comprised of a solenoid, an actuating rod that stretches or retracts from the solenoid when the solenoid is electrified, an elastic element, and the second locking device fixed to the actuating rod;
wherein the elastic element is located between the solenoid and the second locking device, one end of the elastic element abuts against a locating stub formed in the recess.

3. The electric strike according to claim 1 or claim 2, wherein:
the adjustment device is a screw;
the housing having a through hole providing one end of the screw with an access to the recess to abut and push the electromagnetic actuating device;
the through hole is provided with threads fit to the screw.

4. The electric strike according to claim 1, wherein:
the adjustment device is a stick with one end formed in a shape that facilitates operating by a hand tool from outside of the electric strike and a pin protruding from the side of the stick;
the housing having a stepped through hole connecting the recess to outside for accommodating the stick and the pin and providing a channel for the slide of the stick therein when it abuts against or pushes the electromagnetic actuating device;
the through hole having a first stage and a second stage, by operating from outside to make the stick move a distance linearly in the direction parallel to the longitudinal axis of the electromagnetic actuating device and rotate an angle, the pin abuts against the first stage of the through hole to enable the second locking device to move to a locked position with respect to the first locking device, or the pin abuts against the second stage of the through hole to enable the second locking device to move to an unlocked position with respect to the first locking device.

5. The electric strike according to claim 2, wherein:
the adjustment device is a stick with one end formed in a shape that facilitates operating by a hand tool from outside of the electric strike and a pin protruding from the side of the stick;
the housing having a stepped through hole connecting the recess to outside for accommodating the stick and the pin and providing a channel for the slide of the stick therein when it abuts against or pushes the electromagnetic actuating device;
the through hole having a first stage and a second stage, by operating from outside to make the stick move a distance linearly in the direction parallel to the longitudinal axis of the electromagnetic actuating device and rotate an angle, the pin abuts against the first stage of the through hole to enable the second locking device to move to a locked position with respect to the first locking device, or the pin abuts against the second stage of the through hole to enable the second locking device to move to an unlocked position with respect to the first locking device.

6. The electric strike according to claim 1, wherein:
the first locking device is a bump, the second locking device is a block, the chamber and the recess are separated from each other but at least communicate partly, such that in the path of the movement of the block there is a position in which the block is opposite to the bump to prevent the lever from rotating.

7. The electric strike according to claim 2, wherein:
the first locking device is a bump, the second locking device is a block, the chamber and the recess are separated from each other but at least communicate partly, such that in the path of the movement of the block there is a position in which the block is opposite to the bump to prevent the lever from rotating.

8. The electric strike according to claim 3, wherein:
the through hole in the housing is formed as a threaded hole including a counterbore.

9. The electric strike according to claim 8, wherein the depth of the counterbore is configured such that when the screw is threaded into a position in which the head of the screw is flush with the top edge of the counterbore, or the screw is threaded into a position in which the head of the screw is in contact with the bottom edge of the counterbore, the second locking device is enabled to move to the locked position or the unlocked position with respect to the first locking device respectively.

10. The electric strike according to claim 9, wherein a lock washer is disposed in the gap between the exterior of the head of the screw and the counterbore.

11. The electric strike according to claim 1, wherein the housing comprises a base and a shell, a plurality of sawtoothed protrusions and depressions which can engage with each other are provided on the base and the shell respectively, such that during assembling, the relative position of the base and the shell is adjustable and not tended to deflect.

12. The electric strike according to claim 2, wherein the housing comprises a base and a shell, a plurality of sawtoothed protrusions and depressions which can engage with each other are provided on the base and the shell respectively, such that during assembling, the relative position of the base and the shell is adjustable and not tended to deflect.

13. An electric strike, comprising:
a housing, formed with a chamber and a recess therein;
a lever, disposed in the chamber and able to rotate an angle in the chamber, the lever is provided with a bump;
an electromagnetic actuating device, having a longitudinal axis and disposed in the recess, the recess allowing the electromagnetic actuating device to move a distance therein along the longitudinal axis; the electromagnetic actuating device comprising of a solenoid, an actuating rod that stretches or retracts from the solenoid when the solenoid is electrified, an elastic element, and a block fixed to the actuating rod; the elastic element located between the solenoid and the second locking device, and one end of the elastic element abutting against a locating stub formed in the recess;
an adjustment device, adapted to be fitted through the housing in a manner that it can be moved parallel to the longitudinal axis of the electromagnetic actuating device, wherein:
the adjustment device is a screw, one end of the adjustment device abuts against the electromagnetic actuating device, another end of the adjustment device can be manipulated from outside of the electric strike to change its position;
when an door security mode is set, a linear position of the adjustment device is changed by manipulating from outside to push the electromagnetic actuating device to move a distance in the recess along the longitudinal axis, then the block is moved to a locked position or an unlocked position with respect to the bump, a displacement of the block on the electromagnetic actuating device is generated when the solenoid is electrified, the displacement enables the block to change from the set locked position to the unlocked position, or from the set unlocked position to the locked position;
the housing has a through hole providing one end of the adjustment device with an access to the recess to abut against and push the solenoid of the electromagnetic actuating device, and the through hole is provided with threads fit to the screw; and
the chamber and the recess are separated from each other but at least communicate partly, such that in the path of the movement of the second locking device there is a position in which the second locking device is opposite to the first locking device to prevent the lever from rotating or stretching.

14. The electric strike according to claim 13, wherein the housing comprises a base and a shell, a plurality of sawtoothed protrusions and depressions are provided on the base and the shell respectively for engagement, such that during assembling, the relative position of the base and the housing is adjustable and not tended to deflect.

15. An electric strike, comprising:
a housing, formed with a chamber and a recess therein;
a lever, disposed in the chamber and able to rotate an angle in the chamber and being provided with a bump;
an electromagnetic actuating device, having a longitudinal axis and disposed in the recess, the recess allowing the electromagnetic actuating device to move a distance therein along the longitudinal axis, a block disposed on the electromagnetic actuating device, a displacement of the block being generated when the actuating device is driven by an electromagnetic force;
a stick, one end of the stick formed with a tool notch that facilitates operating by a hand tool from outside of the electric strike and can be manipulated from outside of the electric strike to change its position, a pin protruding from the side of the stick, and the other end of the stick abutting against the electromagnetic actuating device; wherein:
the housing having a stepped through hole connecting the recess to outside for accommodating the stick and the pin and providing a channel for the stick to slide therein and push the electromagnetic actuating device;
when a door security mode is set, a linear position of the stick is changed by manipulating from outside to push the electromagnetic actuating device to move a distance in the recess along the longitudinal axis, the block is therefore moved to a locked position or an unlocked position with respect to the bump; a displacement of the block on the electromagnetic actuating device is generated when the actuating device is driven by an electromagnetic force, the displacement enables the block to change from the set locked position to the unlocked position, or from the set unlocked position to the locked position;
the electromagnetic actuating device comprises a solenoid, an actuating rod able to stretch or retract from the solenoid when the solenoid is electrified, an elastic element, and the block fixed to the actuating rod; the elastic element is located between the solenoid and the block, one end of the elastic element abuts against a locating stub formed in the recess;
the through hole is provided with a first stage and a second stage, by operating from outside to make the stick move a distance linearly in the direction parallel to the longitudinal axis and rotate an angle, the pin abuts against the first stage or the second stage of the through hole and the bump is enabled to move to a locked position or an unlocked position with respect to the block respectively; and
the chamber and the recess are separated from each other but at least communicate partly, such that in the moving path of the block there is a position in which the block is opposite to the bump to prevent the lever from rotating.

16. The electric strike according to claim 15, wherein the housing comprises a base and a shell, a plurality of sawtoothed protrusions and depressions which can engage with each other are provided on the base and the shell respectively, such that during assembling, the relative position of the base and the shell is adjustable and not tended to deflect.

17. An electric strike, comprising:
a housing, formed with a chamber and a recess therein;
a lever, disposed in the chamber and able to rotate an angle in the chamber, the lever having a bump;
an electromagnetic actuating device, having a longitudinal axis and disposed in the recess, the recess allows the electromagnetic actuating device to move a distance linearly therein along the longitudinal axis; the electromagnetic actuating device comprising a solenoid, an actuating rod able to stretch or retract from the solenoid when the actuating device is driven by an electromagnetic force, an elastic element, and a block fixed to the actuating rod; the elastic element located between the solenoid and the block with one end abutting against a locating stub formed in the recess;
a screw, adapted to be fitted through the housing in a manner that it can be moved parallel to the longitudinal axis direction of the electromagnetic actuating device, one end of the screw abutting against the solenoid, the other end of the screw formed in a shape that can be easily manipulated from outside of the electric strike; wherein:
when an door security mode is set, a linear position of the screw is changed by manipulating from outside to push the electromagnetic actuating device to move a distance linearly in the recess, then the block is moved to a locked position or an unlocked position with respect to the bump, a displacement of the block on the electromagnetic actuating device is generated when the solenoid is electrified, the displacement enables the block to change from the set locked position to the unlocked position, or from the set unlocked position to the locked position;
the chamber and the recess are separated from each other but at least communicate partly, such that in the moving path of the block there is a position in which the block is opposite to the bump to prevent the lever from rotating or stretching;
the housing has a through hole providing one end of the screw with an access to the recess to abut and push the solenoid, the through hole is provided with threads fit to the screw, and one end of the through hole facing outside is formed as a counterbore;
the depth of the counterbore is configured such that when the screw is threaded into a position in which the head of the screw is flush with the top edge of the counterbore, or the screw is threaded into a position in which the head of the screw is in contact with the bottom edge of the counterbore, the block is enabled to move to the locked position or the unlocked position with respect to the bump respectively.

18. The electric strike according to claim 17, wherein a lock washer is disposed in the gap between the exterior of the head of the screw and the counterbore.
